(19) United States
(12) Patent Application Publication
(10) Pub. No.: US 2026/0184837 A1
(43) Pub. Date: Jul. 2, 2026

(54) POLYURETHANE COMPOSITION

(71) Applicant: Dow Global Technologies LLC, Midland, MI (US)

(72) Inventors: Yanbin Fan, Shanghai (CN); Jun Ma, Shanghai (CN); Daoyong Chen, Shanghai (CN); Xiayun Huang, Shanghai (CN); Adam L. Grzesiak, Midland, MI (US); Hongyu Chen, Shanghai (CN)

(21) Appl. No.: 18/867,783

(22) PCT Filed: Jul. 21, 2022
(86) PCT No.: PCT/CN2022/107092

§ 371 Date: Nov. 20, 2024

(51) Int. Cl. C08G 18/10; C08G 18/32; D06N 3/00; D06N 3/14

(52) U.S. Cl. CPC C08G 18/10; C08G 18/3206; D06N 3/0088; D06N 3/147

(57) ABSTRACT

A polyurethane composition includes from 50 wt % to 98 wt % of an isocyanate component, based on a total weight of the polyurethane composition, the isocyanate component including, from 7 wt % to 55 wt % of a first isocyanate-terminated prepolymer derived from a siloxane-caprolactone block copolymer polyol, based on a total weight of the isocyanate component, and from 45 wt % to 93 wt % of a second isocyanate-terminated prepolymer derived from a polyester polyol, based on the total weight of the isocyanate component. The polyurethane composition further includes from 2 wt % to 50 wt % of an isocyanate-reactive component, based on the total weight of polyurethane composition, the isocyanate-reactive component including a chain extender.

### FIELD

The present disclosure relates to a polyurethane composition, more particularly to a two-component polyurethane composition.

### INTRODUCTION

Polyurethanes are used globally and can be produced as the reaction product of isocyanate-reactive compounds and isocyanates. Many applications for polyurethanes, such as synthetic leather, may require both high strength, high elongation at break, and low thermal conductivity. However, it's challenging to produce such polyurethanes. Existing reports about ductilizing and strengthening polyurethanes are limited to the employment of nano-fillers. For example, nano-fillers based on melanin, cellulose or graphene oxide (GO) were reported to bring both high strength and elongation at break to polyurethanes. However, many nano-fillers are dark in color, difficult to store and handle in a large scale as well as raising environmental concerns about the life cycle released particulate matter, which limits their applications. Therefore, there is a need for polyurethane compositions that provide high strength, high elongation at break, and low thermal conductivity.

### SUMMARY

In an aspect, a polyurethane composition includes from 50 wt % to 98 wt % of an isocyanate component, based on a total weight of the polyurethane composition, the isocyanate component including, from 7 wt % to 55 wt % of a first isocyanate-terminated prepolymer derived from a siloxane-caprolactone block copolymer polyol, based on a total weight of the isocyanate component, and from 45 wt % to 93 wt % of a second isocyanate-terminated prepolymer derived from a polyester polyol, based on the total weight of the isocyanate component. The polyurethane composition further includes from 2 wt % to 50 wt % of an isocyanate-reactive component, based on the total weight of polyurethane composition, the isocyanate-reactive component including a chain extender.

### DETAILED DESCRIPTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference. As disclosed herein, “and/or” means “and, or as an alternative”. All ranges include endpoints unless otherwise indicated. As disclosed herein, all percentages mentioned herein are by weight, and temperatures in ° C., unless specified otherwise.

### Polyurethane Composition

In an aspect, the present disclosure provides a polyurethane composition that includes a blend of isocyanate-terminated prepolymers. The polyurethane composition is a two-component composition. As used herein, the term “two-component” means that the composition is provided in parts separated from each other before making them react. For example, the isocyanate component and the isocyanate-reactive component of the composition can be prepared, stored, transported and served separately, and combined shortly or immediately, for example, in a mixer, to form a reactive mixture. It is contemplated that when these two components are brought into contact, a curing reaction begins in which the isocyanate-reactive groups react with the isocyanate groups to form a cured composition. The reactive polyurethane composition formed by bringing the two components into contact can be referred to as “reactive liquid intermediates” or a “reactive mixture.”

The mixing ratios between the isocyanate component and the isocyanate-reactive component are not strictly limited. The polyurethane composition may have an isocyanate index, determined as [active isocyanate groups/active hydrogen groups], from 0.60 to 1.80 (e.g., 0.80 to 1.50, 0.90 to 1.20, etc.). The isocyanate index is defined as the molar stoichiometric excess of isocyanate moieties in a reaction mixture with respect to the number of moles of isocyanate-reactive units (active hydrogens available for reaction with the isocyanate moiety). An isocyanate index of 1.00 means that there is no stoichiometric excess, such that there is 1.0 mole of isocyanate groups per 1.0 mole of isocyanate-reactive groups. The polyurethane composition may be described as solvent-free.

The polyurethane composition may include from 50 wt % to 98 wt % (e.g., 60 wt % to 98 wt %, 70 wt % to 98 wt %, 80 wt % to 98 wt %, 90 wt % to 98 wt %, etc.) of the isocyanate component, based on a total weight of the polyurethane composition. The polyurethane composition may include from 2 wt % to 50 wt % (e.g., 2 wt % to 40 wt %, 2 wt % to 30 wt %, 2 wt % to 20 wt %, 2 wt % to 10 wt %, etc.) of the isocyanate-reactive component, based on a total weight of the polyurethane composition.

For embodiments, the isocyanate component includes a blend of isocyanate-terminated prepolymers, also referred to as polyurethane prepolymer, which can be converted into a final product by reaction with an isocyanate-reactive component that includes at least chain extender. Each isocyanate-terminated prepolymer may be made by partially reacting a polyisocyanate with polyol, so as to form a polymer having a urethane linkage and at least one terminal isocyanate (NCO) group.

### Isocyanate Component

In an aspect, the isocyanate component provides a blend of at least two different isocyanate (NCO)-terminated prepolymers. The isocyanate-terminated prepolymer(s) can be prepared, packaged, stored and transported as an independent product. The isocyanate-terminated prepolymers may have a low viscosity, be moisture resistant (hydrophobic), and storage stable.

The first isocyanate-terminated prepolymer is derived from a siloxane-caprolactone block copolymer polyol, such that it is the reaction product of a polyisocyanate and the siloxane-caprolactone block copolymer polyol. The second isocyanate-terminated prepolymer is derived from a polyester polyol, such that it is the reaction product of a polyisocyanate and the polyester polyol. The isocyanate component includes 7 wt % to 55 wt % (e.g., 8 wt % to 52 wt %, 10 wt % to 40 wt %, 10 wt % to 30 wt %, 10 wt % to 25 wt %, 15 wt % to 25 wt %, etc.) of the first isocyanate-terminated prepolymer, based on a total weight of the isocyanate component. The isocyanate component includes 45 wt % to 93 wt % (e.g., 48 wt % to 92 wt %, 50 wt % to 90 wt %, 60 wt % to 90 wt %, 70 wt % to 90 wt %, 75 wt % to 85 wt %, etc.) of the second isocyanate-terminated prepolymer, based on a total weight of the isocyanate component. A weight ratio of the first isocyanate-terminated prepolymer to the second isocyanate-terminated prepolymer may be from >5:95, and <60:40 (e.g., 7:93, 8:92, 9:91 or 10:90, 15:85 to 25:75, 40:60, 45:55, 50:50 or 55:45)

The polyisocyanate may be an aromatic isocyanate, an aliphatic isocyanate, a carbodiimide modified isocyanate compounds, and the modifications/isomers/combinations thereof. Examples include, e.g., methylene diphenyl diisocyanate (MDI) toluene-diisocyanate (TDI), hexamethylene diisocyanate (HDI), isophorone diisocyanate (IPDI), xylene diisocyanate (XDI), and methylene bis-cyclohexyl isocyanate (HMDI).

The isocyanate component may consist essentially of (e.g., consists of) the first and second isocyanate-terminated prepolymers. A weight ratio of the first isocyanate-terminated prepolymer to the second isocyanate-terminated prepolymer may be from >5:95, and <60:40, e.g., from 7:93, 8:92, 9:91 or 10:90, 15:85 to 25:75, 40:60, 45:55, 50:50 or 55:45. The first isocyanate-terminated prepolymer is derived from a siloxane-caprolactone block copolymer polyol, such that it is the reaction product of a polyisocyanate and the siloxane-caprolactone block copolymer polyol. By siloxane-caprolactone block copolymer polyol it is meant a copolymer having at least one siloxane block and a caprolactone (e.g., polymerized caprolactone) block. By caprolactone it is meant the seven membered ring having the formulation C₆H₁₀O₂, which may also be referred to as &-caprolactone and/or hexano-6-lactone. For example, a siloxane having at least two terminal hydroxyl groups may act as an initiator (e.g., form a middle block) such that caprolactone is added to the initiator via ring opening polymerization starting at the terminal hydroxyl groups of the siloxane initiator. The siloxane may be a poly(dimethyl siloxane)diol, wherein the hydroxyl group is not directly linked to the silicon atom (e.g., bis(hydroxyalkyl) terminated poly(dimethylsiloxane). The hy droxyalkyl of the bis(hydroxyalkyl) terminated poly(dimethylsiloxane) may comprise a group derived from a 1,2-epoxide, such as, ethylene oxide, 1,2-epoxypropane, 1,2-epoxycyclohexane, or 1,2-epoxybutane, by opening of the oxirane ring.

The siloxane may have a weight average molecular weight from 500 to 7,500 g/mol (e.g., 600 to 7,000, 750 to 5,000, 800 to 1250 g/mol, or 900 to 1100 g/mol, etc.)

For the bis(hydroxyalkyl) terminated poly(dimethylsiloxane) initiator, the alkyl can be a C₁-C₁₄ (e.g., C₁-C₁₀, C₁-C₈, etc.) alkyl which may be optionally interrupted by —O—, N— or —S—. For example, the siloxane initiator may have a formula (I) as shown below:

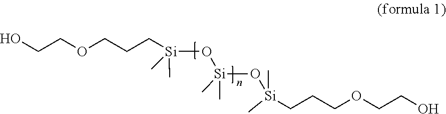

wherein n can be an integer from 0-100, e.g., from 0, 1, 2, 3, 5, 8, 9 and up to 90, 70, 50, 40, 35, 30, 25, 20, 15, or 11 . . .

In exemplary embodiments, the siloxane-caprolactone block copolymer polyol is the reaction product of a bis(hydroxyalkyl) terminated poly(dimethylsiloxane) as an initiator and caprolactone addition via ring-opening polymerization. The resultant siloxane-caprolactone block copolymer polyol may have a weight average molecular weight from 500 g/mol to 8000 g/mol (e.g., 1000 g/mol to 4000 g/mol. 1500 g/mol to 3000 g/mol, 1800 g/mol to 2200 g/mol, 2000 g/mol to 2150 g/mol, etc.) In exemplary embodiments, the bis(hydroxyalkyl) terminated poly(dimethylsiloxane) has a formula (I) as described above.

In exemplary embodiments, the siloxane-caprolactone block copolymer polyol may be an A-B-A type triblock caprolactone-siloxane-caprolactone block copolymer, wherein A represents caprolactone unit(s), B represents siloxane unit(s). In some embodiments, the siloxane-caprolactone block copolymer polyol has a siloxane segment content of greater than 4.2 wt % and less than 92 wt % (e.g., 5 wt % to 90 wt %, 8 wt % to 80 wt %, 15 wt % to 70 wt %, etc.) based on the weight of the siloxane-caprolactone block copolymer polyol, block copolymer polyol. The overall polyurethane composition may have a siloxane content from 3.0 wt % to 15.0 wt % (e.g., 3.0 wt % to 14 wt %), based on a total weight of the polyurethane composition.

The block copolymers can contain siloxane blocks and caprolactone blocks in any relative amount. For example, the copolymer may contain from 5 wt % to 95 wt % (e.g., 30 wt % to 70 wt %, 40 wt % to 60 wt %, etc.) of siloxane blocks and from 5 wt % to 95 wt % (e.g., 30 wt % to 70 wt %, 40 wt % to 60 wt %, etc.) of caprolactone blocks, based on total weight of the siloxane-caprolactone block copolymer polyol.

A second isocyanate-terminated prepolymer is derived from a polyester polyol, such that it is the reaction product of a polyisocyanate and the polyester polyol. The polyester polyol may have a high molar cohesive energy of >17.2 KJ/mol (e.g., ≥19.9 kJ/mol, from 25 KJ/mol to 45 KJ/mol, from 30 KJ/mol to 40 KJ/mol, from 35 KJ/mol to 40 KJ/mol, etc.). The polyester polyol may have a nominal hydroxyl functionality from 2 to 5 (e.g., may be a diol or triol). The polyester polyol may have a weight average molecular weight of at least 500 g/mol, least 800 g/mol, at least 1000 g/mol, at least 1500 g/mol, at least 1800 g/mol, and/or less than 3500 g/mol.

The polyester polyol may be a polycaprolactone polyol, such that it is derived from polymerization of caprolactone monomer. The polycaprolactone polyol may be a diol. The polycaprolactone polyol may have a weight average molecular weight from 500 g/mol to 3500 g/mol (e.g., 500 g/mol to 3000 g/mol, 1000 g/mol to 2500 g/mol, 1500 g/mol to 2500 g/mol, 1900 g/mol to 2100 g/mol, etc.)

### Isocyanate-Reactive Component

The isocyanate-reactive component includes at least one chain extender and may optionally include other additives. Exemplary chain extenders include alcohols and/or amines having a low weight average molecular weight of less than 1000 g/mol, less than 750 g/mol, less than 500 g/mol, less than 250 g/mol, and/or greater than 50 g/mol. The chain extender may be a diol, triol, or diamine. An exemplary chain extender includes butanediol.

The chain extender may account for from 50 wt % to 100 wt % (e.g., 60 wt % to 100 wt %, 70 wt % to 100 wt %, 80 wt % to 100 wt %, 90 wt % to 99.9 wt %, 95 wt % to 99.9 wt %, etc.) of a total weight of the isocyanate-reactive component.

The isocyanate-reactive component may include one or more additives, such as catalysts, plasticizers, flame retardants, pigments, adhesion promoters, rheology modifiers, polymerization inhibitors, fillers, or any combination thereof. For example, the isocyanate-reactive component may include one or more catalysts to adjust the reaction kinetics and the amount may be from 0-3 wt % based on the total weight of the isocyanate-reactive component.

The isocyanate-reactive component may be solvent-free. As used herein, the term “solvent-free” means that the composition can be applied (e.g., up to one hundred percent solids) without either organic solvent or an aqueous carrier. In some embodiments of the present disclosure, the composition comprises less than 4% by weight, less than 1% by weight, less than 0.1% by weight, less than 100 ppm by weight, less than 10 ppm by weight, and/or less than 1 ppm by weight of any organic or inorganic solvent or water, or is free of any organic or inorganic solvent or water.

The polyurethane composition may be substantially free of any polyether polyols such as PPG, e.g., comprises less than 1% by weight, less than 0.1% by weight, less than 100 ppm by weight less than 10 ppm by weight, etc., based on the total weight of the polyurethane composition, or is free of any polyether polyols. The polyurethane composition may be substantially free of any nano-fillers such as melanin, cellulose or graphene oxide, e.g., comprises less than 1% by weight, less than 0.1% by weight, less than 100 ppm by weight less than 10 ppm by weight, etc., based on the total weight of the polyurethane composition, or is free of any nano-fillers.

### Application of the Polyurethane Composition

In a further aspect, the present disclosure provides an artificial leather made using the polyurethane composition. For example, the prepolymer blend may be mixed with isocyanate-reactive components using a high-pressure mixing head and then poured and casted/cured on basic fabrics such as textiles to form the artificial leather product. Release paper with certain decorative figures may be applied onto the un-cured polyurethane resin and then detached after complete curing as well as formation artificial leather of the polyurethane composition.

In some embodiments, the polyurethane composition may be cured at a room temperature (about 25° C.). In some embodiments, the curable mixture can be subjected to pressure or heat (e.g., at a temperature of from 30° C. to 120° C. and/or 30° C. to 90° C.).

### EXAMPLES

Some embodiments will now be described in the following Examples, wherein all parts and percentages are by weight unless otherwise specified. All molecular weight is based on weight average unless otherwise specified.

### Raw Materials

TABLE 1
Raw materials used in the examples

| Category | Chemical Name | Specification | Supplier |
|---|---|---|---|
| Polyol | Poly(ε-caprolactone) diol | Molecular weight 2000 g/mol. | Ju Ren Co., Ltd. |
| | | density 1.073 g/cm³, | |
| | | functionality 2, and calculated | |
| | | molar cohesive energy of 37.5 | |
| | | kJ/mol | |
| Polyol | Poly(dimethyl siloxane) diol | Molecular weight 2000 g/mol, | Shanghai Tangui |
| | | CAS No. 156327-07-0, | Advanced Material |
| | | functionality 2 | Technology Co., |
| | | | Ltd |
| Polyol | Polyethylene glycol initiated diol | VORANOL ™ 2000LM, | The Dow |
| | | Molecular weight 2000 g/mol, | Chemical |
| | | functionality 2, and calculated | Company |
| | | molar cohesive energy of 17.2 | |
| | | kJ/mol | |
| Micromolecular | Poly(dimethyl siloxane) diol i.e. | Molecular weight 1000 g/mol, | Shanghai Tangui |
| initiator | HO-PDMS-OH | CAS No. 156327-07-0, | Advanced Material |
| | | functionality 2 | Technology Co., |
| | | | Ltd. |
| Monomer | ε-caprolactone | Molecular weight 114 g/mol, | Ju Ren Co., Ltd. |
| | | CAS No. 502-44-3 | |
| Chain extender | 1,4-Butanediol (BDO) | Molecular weight 92 g/mol | Adamas Co., Ltd. |
| | | density 1.01 g/cm³ | |
| Catalyst | Dabco ® 33 s | 33% triethylene diamine | Evonik |
| | | (TEDA) diluted in 67% of 1,4- | |
| | | BDO | |
| Catalyst | Tyzor TBT | Molecular weight 340 g/mol, | Sigma |
| | | CAS No. 9047-53-4 | |
| Isocyanate | 4,4′-Diphenylmethane Di- | Molecular weight 250 g/mol, | Wanhua Chemical |
| | isocyanate | CAS No. 101-68-8, density | Group Co., Ltd. |
| | | 1.13 g/cm³; | |
| Polymerization | Benzoyl Chloride | Molecular weight 140 g/mol, | Adamas Co., Ltd. |
| inhibitor | | CAS No. 98-88-4, density 1.21 | |
| | | g/cm³ | |

### Synthesis of Poly(ε-caprolactone)-b-Poly(dimethyl siloxane)-b-Poly(ε-caprolactone) (HO-PCL-PDMS-PCL-OH)

HO-PCL-PDMS-PCL-OH (having Mw=2080 g/mol, PDI=1.51; weight ratio between PDMS/PCL=1:1) was synthesized via ring-opening polymerization of &-caprolactone using HO-PDMS-OH as the macromolecular initiator. 100 g of the macromolecular initiator, 100 g ε-caprolactone and n-butyl titanate (TBT, 25 ppm) were fed into 500 ml glass reactor equipped with a vacuum pump and oil bath under nitrogen atmosphere at room temperature. With stirring, the system was allowed to react at 120° C. for 17 h, followed by application of vacuum under 150 mbar and 135° C. for 3 h. The final product was cooled down to 80° C., then filtered, packaged and sampled for determination.

### Synthesis of Poly(ε-caprolactone)-b-Poly(dimethyl siloxane)-b-Poly(ε-caprolactone) Polyurethane Prepolymer (Pre_{PCL-PDMS-PCL})

27.67 g of MDI and 0.01 g of benzoyl chloride were fed into a 500 mL three-necked round bottom flask and mixed at 55° C. under nitrogen atmosphere. After that, 72.32 g of the HO-PCL-PDMS-PCL-OH was charged into the flask and incubated at 85° C. for 2 hours to obtain the prepolymer. The prepolymer was then cooled to 60° C. for packaging, sampling and characterization.

### Synthesis of Poly(ε-caprolactone) Polyurethane Prepolymer (Pre_{PCL})

27.67 g of MDI and 0.01 g of benzoyl chloride were fed into a 500 mL three-necked round bottom flask and mixed at 55° C. under nitrogen atmosphere. After that, 72.32 g of the poly(ε-caprolactone) diol was charged into the flask and incubated at 85° C. for 2 hours to obtain the prepolymer. The prepolymer was then cooled to 60° C. for packaging, sampling and characterization.

### Synthesis of Poly(Dimethyl Siloxane) Polyurethane Prepolymer (Pre_{PDMS}):

27.67 g of MDI and 0.01 g of benzoyl chloride were fed into a 500 mL three-necked round bottom flask and mixed at 55° C. under nitrogen atmosphere. After that, 72.32 g of the Poly(dimethyl siloxane)diol (2000 g/mol) was charged into the flask and incubated at 85° C. for 2 hours to obtain the prepolymer. The prepolymer was then cooled to 60° C. for packaging, sampling and characterization.

### Synthesis of Polypropylene Glycol Polyurethane Prepolymer (Pre_{PPG}):

27.67 g of MDI and 0.01 g of benzoyl chloride were fed into a 500 mL three-necked round bottom flask and mixed at 55° C. under nitrogen atmosphere. After that, 72.32 g of VORANOL™ 2000 LM was charged into the flask and incubated at 85° C. for 2 hours to obtain the prepolymer. The prepolymer was then cooled to 60° C. for packaging, sampling and characterization.

### Synthesis of the Comparative Example A (CE.A)

CE.A was prepared via the following hand-mixing procedures. (a) Preheat the prepolymer Pre_{PCL} at 80° C. for at least 30 min to ensure a low viscose liquid is achieved before use. (b) Preheat the aluminum molds with releasing agent at 110° C. for at least 30 min before the use. (c) Blend 40 g of Pre_{PCL} and 2.61 g of BDO containing Catalyst 1 (stored at room temperature) with a Flacktec speedmixer at 2500 rpm for 1 min to efficiently mix the components and remove any air bubbles or dissolved gas. (d) Pour the mixture into the preheated molds and keep the system at 110° C. for 1 h, followed by cooling to below 60° C. (e) De-mold the polyurethane samples carefully to avoid damage to the samples with gloves and then post-cure the polyurethane samples at 110° C. for at least 16 h.

### Synthesis of Comparative Example B (CE.B)

CE.B was prepared via the following hand-mixing procedures. (a) Mixing 2 g of the prepolymer Pre_{PCL-PDMS-PCL} and 38 g of the prepolymer Pre_{PCL} with a Flacktec Speed mixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

### Synthesis of Comparative Example (CE.C)

CE.C was prepared via the following hand-mixing procedures. (a) Mixing 24 g of the prepolymer Pre_{PCL-PDMS-PCL} and 16 g of the prepolymer Pre_{PCL} with a Flacktec speedmixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

### Synthesis of Comparative Example D (CE.D)

CE.D was prepared via the following hand-mixing procedures. (a) Preheat the prepolymer Pre_{PCL-PDMS-PCL} at 80° C. for at least 30 min to ensure a low viscose liquid is achieved before use. (b) Preheat the aluminum molds with releasing agent at 110° C. for at least 30 min before the use. (c) Blend 40 g of the prepolymer Pre_{PCL-PDMS-PCL} and 2.61 g of BDO containing Catalyst 1 (stored at room temperature) with a Flacktec speedmixer at 2500 rpm for 1 min to efficiently mix the components and remove any air bubbles or dissolved gas. (d) Pour the mixture into the preheated molds and keep the system at 110° C. for 1 h, followed by cooling to below 60° C. (e) De-mold the polyurethane samples carefully to avoid damage to the samples with gloves and then post-cure the polyurethane samples at 110° C. for at least 16 h.

### Synthesis of Comparative Example E (CE.E)

CE.E was prepared via the following hand-mixing procedures. (a) Preheat the prepolymer Pre_{PDMS} at 80° C. for at least 30 min to ensure a low viscose liquid is achieved before use. (b) Preheat the aluminum molds with releasing agent at 110° C. for at least 30 min before the use. (c) Blend 40 g of the prepolymer Pre_{PDMS} and 2.61 g of BDO containing Catalyst 1 (stored at room temperature) with a Flacktec speedmixer at 2500 rpm for 1 min to efficiently mix the components and remove any air bubbles or dissolved gas. (d) Pour the mixture into the preheated molds and keep the system at 110° C. for 1 h, followed by cooling to below 60° C. (e) De-mold the polyurethane samples carefully to avoid damage to the samples with gloves and then post-cure the polyurethane samples at 110° C. for at least 16 h.

### Synthesis of Comparative Example F (CE.F)

CE.F was prepared via the following hand-mixing procedures. (a) Mixing 20 g of the prepolymer Pre_{PDMS} and 20 g of the prepolymer Pre_{PCL} with a Flacktec speedmixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

### Synthesis of Comparative Example G (CE.G)

CE.G was prepared via the following hand-mixing procedures. (a) Mixing 16 g of the prepolymer Pre_{PCL-PDMS-PCL} and 24 g of the prepolymer Pre_{PPG} with a Flacktec speedmixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec. speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

### Synthesis of Working Example 1 (WE.1)

WE.1 was prepared via the following hand-mixing procedures. (a) Mixing 4 g of the prepolymer Pre_{PCL-PDMS-PCL} and 36 g of the prepolymer Pre_{PCL} with a Flacktec speedmixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

### Synthesis of Working Example 2 (WE.2)

WE.2 was prepared via the following hand-mixing procedures. (a) Mixing 8 g of the prepolymer Pre_{PCL-PDMS-PCL} and 32 g of the prepolymer Pre_{PCL} with a Flacktec speedmixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

### Synthesis of Working Example 3 (WE.3)

WE.3 was prepared via the following hand-mixing procedures. (a) Mixing 16 g of the prepolymer Pre_{PCL-PDMS-PCL} and 24 g of the prepolymer Prepc with a Flacktec speedmixer at 2500 rpm for 1 min to efficiently mix the prepolymers. (b) Preheat the prepolymer mixture at 80° C. for at least 30 min to ensure a low viscose liquid is achieved before use. (c) Preheat the aluminum molds with releasing agent at 110° C. for at least 30 min before the use. (d) Blend the 40 g prepolymer mixture and 2.61 g of BDO containing Catalyst 1 (stored at room temperature) with a Flacktec speedmixer at 2500 rpm for 1 min to efficiently mix the components and remove any air bubbles or dissolved gas. (e) Pour the mixture into the preheated molds and keep the system at 110° C. for 1 h, followed by cooling to below 60° C. (f) De-mold the polyurethane samples carefully to avoid damage to the samples with gloves and then post-cure the polyurethane samples at 110° C. for at least 16 h.

The present disclosure describes two product formulations: isocyanate prepolymers showing storage stability, low viscosity and high moisture resistance, as summarized in Table 2, and polyurethane compositions showing high mechanical strength, high elongation at brake and low thermal conductivity.

TABLE 2
Specifications and properties

| | | | | | | | | | |
|---|---|---|---|---|---|---|---|---|---|
| CE. A | CE. B | CE. C | CE. D | CE. E | CE. F | CE. G | WE. 1 | WE. 2 | WE. 3 |

Composition (Part A - parts by weight of Prepolymer)

| | | | | | | | | | | |
|---|---|---|---|---|---|---|---|---|---|---|
| Pre_{PCL} | 100 | 95 | 40 | | | 50 | | 90 | 80 | 60 |
| Pre_{PCL-PDMS-PCL} | | 5 | 60 | 100 | | | 20 | 10 | 20 | 40 |
| Pre_{PDMS} | | | | | 100 | 50 | | | | |
| Pre_{PPG} | | | | | | | 80 | | | |

Properties (Part A - Prepolymer)

| | | | | | | | | | | |
|---|---|---|---|---|---|---|---|---|---|---|
| Viscosity | 22 | 16 | 8 | 4 | 0.2 | 7 | 4.5 | 12 | 9 | 12 |
| (Pa · s, 50 C.; | | | | | | | | | | |
| CTQ < 15) | | | | | | | | | | |
| Skinning | 2.0 | 3.0 | 9.5 | 10.0 | 12.0 | 6.0 | 7.0 | 6.0 | 7.0 | 9.0 |
| Time (h); | | | | | | | | | | |
| (CTQ ≥ 5 h) | | | | | | | | | | |
| Storage Stability | Stable | Stable | Stable | Stable | Stable | Instable | Instable | Stable | Stable | Stable |

Composition (Part B - parts by weight)

| | | | | | | | | | | |
|---|---|---|---|---|---|---|---|---|---|---|
| Chain Extender | 6.5 | 6.5 | 6.5 | 6.5 | 6.5 | 6.5 | 6.5 | 6.5 | 6.5 | 6.5 |
| Catalyst 1 | 0.06 | 0.06 | 0.06 | 0.06 | 0.06 | 0.06 | 0.06 | 0.06 | 0.06 | 0.06 |

Properties (Part A and Part B)

| | | | | | | | | | | |
|---|---|---|---|---|---|---|---|---|---|---|
| NCO/OH Index | 1.01 | 1.01 | 1.01 | 1.01 | 1.01 | 1.01 | 1.01 | 1.01 | 1.01 | 1.01 |
| Siloxane wt %* | 0 | 1.7 | 20.4 | 34.0 | 68.0 | 34.0 | 6.8 | 3.4 | 6.8 | 13.6 |
| Caprolactone | 68.0 | 66.3 | 47.6 | 34.0 | 0.0 | 34.0 | 6.8 | 64.6 | 61.2 | 54.4 |
| wt %** | | | | | | | | | | |
| Tensile Strength | 51 | 31 | 36 | 33 | 10 | 24 | 25 | 41 | 62 | 49 |
| (CTQ ≥ 40 MPa | | | | | | | | | | |
| Elongation at | 851 | 1016 | 778 | 754 | 77 | 190 | 530 | 896 | 998 | 930 |
| Break (CTQ ≥ | | | | | | | | | | |
| 800%) | | | | | | | | | | |
| Thermal | 0.343 | 0.334 | 0.321 | 0.293 | 0.268 | 0.288 | 0.310 | 0.318 | 0.312 | 0.316 |
| Conductivity | | | | | | | | | | |
| (CTQ ≤ 0.32 | | | | | | | | | | |
| W/(m · K)) | | | | | | | | | | |

Notes:
*the Siloxane wt. % is calculated based on the total weight of polyurethane.
**the Caprolactone wt. % is calculated based on the total weight of polyurethane.

### REFERRING TO THE EXAMPLES

Working Example 1: Includes prepolymer mixture of Pre_{PCL} (90)/Pre_{PCL-PDMS-PCL} (10), an isocyanate prepolymer mixture composed of 90 wt. % of Pre_{PCL} and 10 wt. % of Pre_{PCL-PDMS-PCL}, showing low viscosity, moisture resistance and storage stability. The corresponding polyurethane derived therefrom show desirable properties of high strength, high elongation at break and low thermal conductivity.

Working Example 2: Includes prepolymer mixture of Pre_{PCL} (80)/Pre_{PCL-PDMS-PCL} (20), an isocyanate prepolymer mixture composed of 80 wt. % of Pre_{PCL} and 20 wt. % of Pre_{PCL-PDMS-PCL}, showing low viscosity, moisture resistance and storage stability. The corresponding polyurethane derived therefrom show desirable properties of high strength, high elongation at break and low thermal conductivity.

Working Example 3, Includes Prepolymer mixture of Pre_{PCL} (60)/Pre_{PCL-PDMS-PCL} (40), an isocyanate prepolymer mixture composed of 60 wt. % of Pre_{PCL} and 40 wt. % of Pre_{PCL-PDMS-PCL}, showing low viscosity, moisture resistance and storage stability. The corresponding polyurethane derived therefrom show desirable properties of high strength, high elongation at break and low thermal conductivity.

In contrast, the comparative examples are as follows:

Com-A: Includes Pre_{PCL}, showing high viscosity and moisture sensitiveness and the corresponding polyurethane derived from Pre_{PCL} shows high strength, low elongation at break and high thermal conductivity.

Com-B. Includes prepolymer mixture of 95 wt. % of Pre_{PCL} and 5 wt. % of Pre_{PCL-PDMS-PCL}, showing high viscosity, moisture sensitiveness and storage stability and the corresponding polyurethane derived therefrom shows low strength, high elongation at break and relatively high thermal conductivity.

Com-C. Includes prepolymer mixture of 40 wt. % of Pre_{PCL} and 60 wt. % of Pre_{PCL-PDMS-PCL}, showing low viscosity, moisture resistance and storage stability and the corresponding polyurethane derived therefrom shows low strength, low elongation at break and relatively low thermal conductivity.

Com-D. Includes Pre_{PCL-PDMS-PCL}, an isocyanate prepolymer based on a tri-block co-polymer diol HO-PCL-PDMS-PCL-OH, showing low viscosity, moisture resistance and storage stability. The corresponding polyurethane derived therefrom show relatively low strength, low elongation at break and low thermal conductivity.

Com-E. Includes Pre_{PDMS}, a poly(dimethyl siloxane) and isocyanate prepolymer, showing low viscosity and moisture resistance and the corresponding polyurethane derived therefrom show relatively low strength, low elongation at break and low thermal conductivity.

Com-F. Includes Pre_{PDMS}/Pre_{PCL} an isocyanate prepolymer mixture composed of equivalent amounts of Pre_{PDMS} and Pre_{PCL}, showing low viscosity, moisture resistance and storage instability. The corresponding polyurethane derived therefrom show low strength, low elongation at break and low thermal conductivity.

Com-G. Includes Pre_{PPG} (60)/Pre_{PCL-PDMS-PCL} (40), a mixture of 60 wt. % of Pre_{PPG} and 40 wt. % of Pre_{PCL-PDMS-PCL}, showing low viscosity, moisture resistance and storage in stability. The corresponding polyurethane derived therefrom show low strength, low elongation at break and relatively low thermal conductivity.

### Experimental Procedures

Viscosity of polyurethane prepolymer was tested by the following procedure below: (Pa·s/50° C.)

During the test, take 1 g prepolymer product, put it on the plate, close the plate, fill the prepolymer between the two plates, and eliminate the bubbles. When the sample temperature is stable, start the rotor to test the rheological properties of variable shear rate.

Mechanical property test was carried out according to GB/T1447

Specimens (1×2×12 mm, n=5) of each polyurethane were prepared and stretched to failure at a rate of 10 mm/min using an Instron 5966 uniaxial tensile tester equipped with a 1 kN load cell. The elastic modulus, tensile strength, and ultimate elongation at break were calculated from the resultant engineering stress/strain curves.

Thermal conductivity was carried out according to ISO/DIS 22007-2.2 (Hotdisk Method) Thermal conductivity was evaluated by hotdisk transient technology with Kapton No. 5465 sensor at 35 mW heating speed and time duration of 40 s for each test.

Skinning time determination for the prepolymers:

Take 10 g of each prepolymer in a 50 ml Plastic beaker, put the beaker in oven under 45% humidity and 23° C. temperature. Start time recording. Periodically take out the beaker and use a plastic stick to touch the surface of the prepolymer softly. With the increasing reaction between the prepolymer and moisture, the surface viscosity increases. Stop the time recording when surface of the prepolymer is not sticky anymore. The duration is recorded as skinning time of the prepolymer.

### Calculation of Molar Cohesive Energy of Polymers

The cohesive energy per chain is defined as the average energy per chain required to separate all the polymer chains in a condensed state into infinite distance from each other. To calculate the cohesive energy, five polymer chains with respective molecular weights are adopted for calculation. The calculations were then carried out using the Forcite module of the Materials Studio (Accelrys inc., San Diego) with COMPASSII force field, and the atomic point charges were calculated by the Gasteiger method. The initial configurations of simulation systems were constructed by randomly distributing the polymer chains in simulation cells using the Amorphous Cell module of the Materials Studio. The cohesive energy per chain was calculated by the following equation:

$${E}_{cohesive} = \frac{( {\sum }_{i = 1}^{5} {E}_{pot}^{isolated} ( i ) - {E}_{pot}^{5} )}{5} where {E}_{pot}^{isolated}$$

is the average potential energy of an isolated polymer chain in vacuum,

$${E}_{pot}^{5}$$

is the average potential energy of the condensed system consisting of five polymer chains. The potential energies of the isolated polymer chains were calculated by averaging 20 frames in 100 picoseconds after the equilibrium simulation of 1 nanosecond. For the condensed system, the potential energy was calculated via the same method after the annealing simulation.

1. A polyurethane composition, comprising,
from 50 wt % to 98 wt % of an isocyanate component, based on a total weight of the polyurethane composition, the isocyanate component including,
from 7 wt % to 55 wt % of a first isocyanate-terminated prepolymer derived from a siloxane-caprolactone block copolymer polyol, based on a total weight of the isocyanate component, and
from 45 wt % to 93 wt % of a second isocyanate-terminated prepolymer derived from a polyester polyol, based on the total weight of the isocyanate component; and
from 2 wt % to 50 wt % of an isocyanate-reactive component, based on the total weight of polyurethane composition, the isocyanate-reactive component including a chain extender.

2. The polyurethane composition of claim 1, wherein the polyester polyol is a polycaprolactone polyol.

3. The polyurethane composition of claim 2, wherein the polycaprolactone polyol is a diol and has a weight average molecular weight from 500 g/mol to 3000 g/mol.

4. The polyurethane composition of claim 1, wherein the siloxane-caprolactone block copolymer polyol is the reaction product of a bis(hydroxyalkyl) terminated poly(dimethylsiloxane) as an initiator and caprolactone addition via ring-opening polymerization and the siloxane-caprolactone block copolymer polyol has a weight average molecular weight from 1000 g/mol from 4000 g/mol.

5. The polyurethane composition of claim 4, wherein the bis(hydroxyalkyl) terminated poly(dimethylsiloxane) has a formula (I): 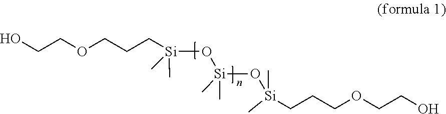
wherein n can be an integer from 0-100.

6. The polyurethane composition of claim 1, wherein the polyurethane composition has a siloxane content from 3.0 wt % to 15.0 wt %.

7. The polyurethane composition of claim 1, wherein the isocyanate component consists essentially of from 10 wt % to 40 wt % of the first isocyanate-terminated prepolymer and from 60 wt % to 90 wt % of the second isocyanate-terminated prepolymer.

8. The polyurethane composition of claim 1, wherein the polyurethane composition is substantially free of polyether polyols and nano-fillers.

9. The polyurethane composition of claim 1, wherein the polyurethane composition is mixed and cast on a base fabric layer to form an artificial leather product.
